(19) United States
(12) Patent Application Publication
(10) Pub. No.: US 2017/0161796 A1
(43) Pub. Date: Jun. 8, 2017

(54) INDIVIDUALIZED RATINGS BASED ON USER PREFERENCES

(71) Applicant: International Business Machines Corporation, Armonk, NY (US)

(72) Inventors: Adam T. Clark, Mantorville, MN (US); Jeffrey K. Huebert, Rochester, MN (US); Aspen L. Payton, Byron, MN (US); John E. Petri, St. Charles, MN (US)

(21) Appl. No.: 14/957,681

(22) Filed: Dec. 3, 2015

(51) Int. Cl. G06Q 30/02

(52) U.S. Cl. CPC G06Q 30/0282

(57) ABSTRACT

A computer system may receive a textual work relating to a work of authorship using an input device that is coupled to the computer system. The computer system may have a processor and a memory storing one or more natural language processors. The computer system may ingest the textual work using the natural language processing modules. The computer system may identify content in the work of authorship that corresponds to one or more ratings components. The computer system may obtain a user profile that indicates a tolerance level of the user to at least one of the ratings components. The computer system may generate a rating for the work of authorship using the user profile.

### BACKGROUND

The present disclosure relates generally to the field of natural language processing, and more particularly to generating an individualized rating for a work of authorship based on a user's preferences.

Many different entertainment mediums, such as movies, have an associated ratings system to identify the group for whom a particular work is appropriate. The ratings are assigned according to the content of the work, which is often broken down into specific categories or components. For example, movie ratings may be influenced by the amount of profanity that appears in the movie, amongst other things. People may use these ratings to determine whether a movie is appropriate for themselves or for someone else. For example, parents often use these ratings when determining whether a particular movie is appropriate for their children. These ratings are assigned based on the attitudes and sensitivities of the general public.

### SUMMARY

Embodiments of the present invention disclose a method, computer program product, and system for generating individualized ratings for a work of authorship based on user preference. A computer system may receive a textual work using an input device that is coupled to the computer system. The computer system may have a processor and a memory storing one or more natural language processors. The textual work may relate to a work of authorship. The computer system may ingest the textual work using the natural language processing modules. The computer system may identify content in the work of authorship that corresponds to one or more ratings components. The computer system may obtain a user profile that indicates a tolerance level of the user to at least one of the ratings components. The computer system may generate a rating for the work of authorship using the user profile. The rating may indicate an appropriateness level of the work of authorship.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates a block diagram of an example computing environment in which illustrative embodiments of the present disclosure may be implemented.

FIG. 2 illustrates a block diagram of an example natural language processing system configured to ingest a textual work relating to a movie and generate an individualized rating for the work of authorship, in accordance with embodiments of the present disclosure.

FIG. 3 illustrates a flowchart of a method for generating an individualized rating for a work of authorship based on user preferences, in accordance with embodiments of the present disclosure.

FIG. 4 illustrates an example scorecard for a movie showing the component scores for four ratings components, in accordance with embodiments of the present disclosure.

FIG. 5 illustrates a flowchart of an example method for adjusting a user profile based on feedback received from the user, in accordance with embodiments of the present disclosure.

FIG. 6 illustrates a flowchart of another method for generating an individualized rating for a work of authorship based on user preferences, in accordance with embodiments of the present disclosure.

FIG. 7 illustrates an example scorecard for a movie showing the ratings for each scene in the movie, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the invention.

### DETAILED DESCRIPTION

Aspects of the present disclosure relate generally to the field of natural language processing, and in particular to generating an individualized rating for a work of authorship based on user preferences. While the present disclosure is not necessarily limited to such applications, various aspects of the disclosure may be appreciated through a discussion of various examples using this context.

Ratings assigned by a ratings board to a work of authorship (e.g., a movie) according to its own ratings system may be unsatisfactory to a user. As used herein, a work of authorship (also referred to as a “work”) includes products of creative or factual expression, such as books, audiobooks, songs, movies, and/or video games. The rating may be unsatisfactory because the user has heightened, or different, sensitivities to specific content (e.g., profanity) compared to the general public. Because the ratings are assigned with an eye to the general public, the ratings may not align with the user's sensitivities. Accordingly, the user may wish to receive an individualized rating according to his own sensitivities to certain types of content.

Embodiments of the present disclosure include a computer-implemented method to automatically generate a rating for a work (e.g., a movie or a video game) according to the individual preferences of the user. In some embodiments, the rating may indicate simply whether the work is appropriate or is not appropriate (e.g., a yes or no). In some embodiments, a specific rating (e.g., a 1 through 10 rating) may be assigned to the work. In some embodiments, the rating may indicate the recommended age of the consumer (e.g., viewer).

In some embodiments, a user can create a user profile that defines what is and is not appropriate to the user (or to the user's child). The profile may indicate a tolerance level for a variety of specific ratings components based on the user's sensitivities. The ratings components may be categories of content that can affect the appropriateness of a work (e.g., a movie) for a specific audience. For example, the ratings components may correspond to violence, nudity, and profanity, amongst others. The ratings components may be general (e.g., violence), or more specific (e.g., violence against animals). The user may assign different tolerance levels to different ratings components. For example, the user profile generated by a parent for his teenager may indicate that the parent allows his teenager to watch movies with moderate use of strong language, but the teenager is only allowed to watch a movie if it has a very low amount of violence. The user may also input specific triggers into the profile, indicating that no matter what the rating is, he is unwilling to watch a movie with specific content in it. For example, an otherwise acceptable movie may be considered inappropriate for a user because it includes a scene with a clown in it if the user indicates that he has a debilitating fear of clowns.

In some embodiments, a single user profile may include profiles for multiple users. For example, a family profile may be generated that has user profiles for multiple members of the family (e.g., a first profile for a young child, a second profile for a teenager, and a third profile for the parents). The computer system may generate individualized ratings for a work (e.g., movie ratings) for each member of the family. For example, a movie may be rated as appropriate for the parents and the teenager, but inappropriate for the young child.

In some embodiments, the user may not generate a detailed user profile. Instead, he may select from a predetermined list of profiles. For example, the user may select a default profile based on his age (or the age of his child). The default profiles may, in some embodiments, be based on other ratings systems. For example, the user may select as their default (or initial) user profile a profile corresponding to the “PG-13” rating. The selected profile may be adjusted over time according to the user's changing preferences and viewing habits.

In some embodiments, the computer system may generate a user profile for the user. The computer system may provide the user with a set of questions. The questions can be “yes or no” questions, or they can be questions that require the user to adjust a sliding scale to indicate his tolerance level. For example, the question may ask “Are you afraid of clowns?” If the user answers yes, the computer-generated user profile may indicate that the user does not want to watch movies or play games that include clowns. As another example, the user may be asked “on a scale of 1 to 10, how acceptable is the use of profanity?” The computer system may then determine the user's tolerance level to profanity based on his answer.

After obtaining a user profile, a natural language processing (NLP) system may ingest a textual work related to a work (e.g., movie script and/or user reviews of a movie). The user review may include reviews generated by other viewers for the movie (e.g., user reviews of the movie posted online), reviews of the movie that are written by professional critics, or reviews of the movie made by other users of the NLP system. The NLP system may parse the movie script and/or reviews to identify content of the movie that fits into the ratings components. The content may include events and themes (e.g., despair). The events may include actions (e.g., acts of violence), places, visual imagery (e.g., nudity), words (e.g., profanity), or actors (e.g., clowns). For example, if the user indicates that he has a fear of clowns, the NLP system may look for signs of clowns in the scene descriptions in the movie script (e.g., “A smiling clown enters the room”). As another example, the NLP system might identify, from user reviews, user sentiments about particular aspects of the movie. For example, users might indicate in their reviews that the movie includes depictions of clowns, or that particular scenes were hard to watch because they included clowns committing acts of violence.

After parsing the textual work (e.g., movie script and/or user reviews) and identifying content that falls into at least one of the ratings components, the NLP system may generate an individualized rating for the work based on the user profile. The NLP system may score each ratings component, and then score the work as a whole. In some embodiments, the NLP system may look at how much of the content of the work (e.g., how many different scenes in a movie or events) corresponds to each of the ratings components in order to score the ratings components. For example, to score a profanity component, the NLP system may count the number of times that profane words were used in the work. In some embodiments, the NLP system may look at the severity of the content. For example, the NLP system may differentiate between one profanity and another (e.g., one word may be considered worse than another). As another example, the computer system may differentiate comedic violence (e.g., slapstick) from cartoon violence.

In some embodiments, generating the score for the components may involve weighting various subcomponents according to user preferences. For example, the user may establish that depictions of comedic violence are generally appropriate, but other depictions of violence are not appropriate. The NLP system may then generate the individualized rating for the work by weighting the scores for the different ratings components according to the user profile.

In some embodiments, the rating for the ingested work may be a binary rating. In other words, the work may be rated as either appropriate or inappropriate for the user. In other embodiments, the rating may be a scaled rating (such as a 1-10). In some embodiments, detailed ratings may be generated for works that indicate why the works received the ratings that they did. The detailed ratings may be provided to the user as a scorecard for the work. For example, the user may see a score for each of the ratings components or for each scene in a movie. The user may also be provided with a reasoning for the score. For example, if a work scored as inappropriate for the user in the profanity component, the user may be provided with an explanation (e.g., a certain profane word was used, or profane words were used 10+ times).

In some embodiments, the user can give direct feedback as to why he found a particular work inappropriate. The feedback can then be used to better train the computer system to generate more accurate ratings. In some embodiments, the user may be prompted to select a specific scene, event, or theme in the work that he felt made it inappropriate. The user may be presented with scenes (or events or themes) that other users found inappropriate, and then asked to choose which (if any) he also found objectionable. The content of those scenes may then be used to generate more accurate movie ratings. For example, if the user routinely selected scenes with spiders in them as inappropriate, the computer system may start filtering out works that include spiders. This may be done even if the user had not previously indicated a dislike of spiders (e.g., no ratings category previously existed in the user profile for spiders).

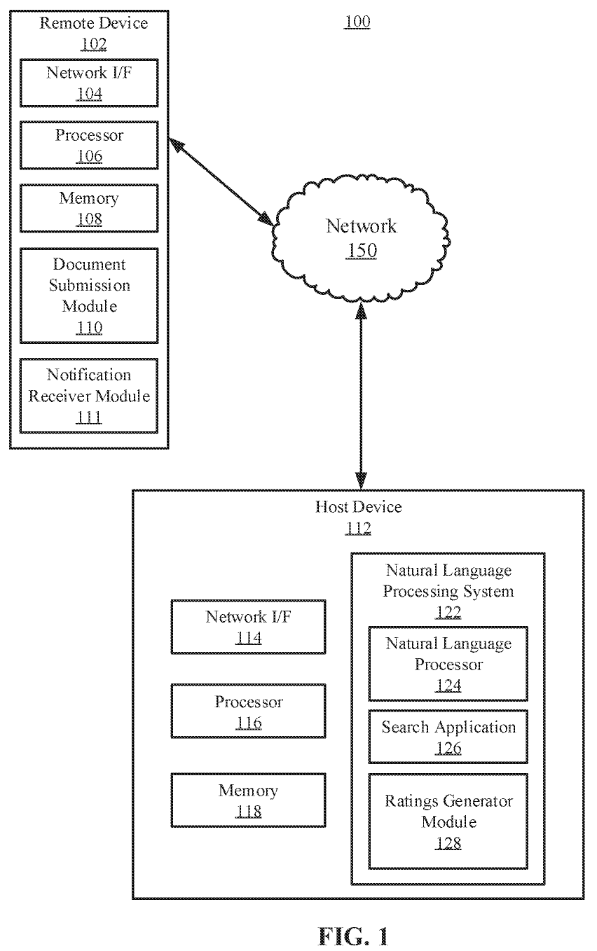

As discussed above, aspects of the disclosure may relate to natural language processing. Accordingly, an understanding of the embodiments of the present disclosure may be aided by describing embodiments of natural language processing systems and the environments in which these systems may operate. While embodiments of the present disclosure may relate to any kind of work of authorship (e.g., movies, songs, books, video games), aspects of the disclosure are discussed in reference to the figures as they relate to the generation of an individualized movie rating for a movie. The present disclosure should not be limited to generating an individualized rating for movies, however. The methods and modules discussed in detail in reference to the figures may also be used to generate individualized ratings for other types of media, such as video games and books. Turning now to the figures, FIG. 1 illustrates a block diagram of an example computing environment 100 in which illustrative embodiments of the present disclosure may be implemented. In some embodiments, the computing environment 100 may include a remote device 102 and a host device 112.

Consistent with various embodiments, the remote device 102 and the host device 112 may be computer systems. The remote device 102 and the host device 112 may include one or more processors 106 and 116 and one or more memories 108 and 118, respectively. The remote device 102 and the host device 112 may be configured to communicate with each other through an internal or external network interface 104 and 114. The network interfaces 104 and 114 may be, for example, modems or network interface cards. The remote device 102 and/or the host device 112 may be equipped with a display or monitor. Additionally, the remote device 102 and/or the host device 112 may include optional input devices (e.g., a keyboard, mouse, scanner, or other input device), and/or any commercially available or custom software (e.g., browser software, communications software, server software, natural language processing software, search engine and/or web crawling software, filter modules for filtering content based upon predefined parameters, etc.). The host device 112 may, in various embodiments, be connected to an output device. The output device may include any device that may be used by a user to read, listen to, or print out a movie rating generated by the host device 112. For example, the output device may be a tablet, an e-reader, or a printer. In some embodiments, the remote device 102 and/or the host device 112 may be servers, desktops, laptops, or hand-held devices.

The remote device 102 and the host device 112 may be distant from each other and communicate over a network 150. In some embodiments, the host device 112 may be a central hub from which remote device 102 can establish a communication connection, such as in a client-server networking model. Alternatively, the host device 112 and remote device 102 may be configured in any other suitable networking relationship (e.g., in a peer-to-peer configuration or using any other network topology).

In some embodiments, the network 150 can be implemented using any number of any suitable communications media. For example, the network 150 may be a wide area network (WAN), a local area network (LAN), an internet, or an intranet. In certain embodiments, the remote device 102 and the host device 112 may be local to each other and communicate via any appropriate local communication medium. For example, the remote device 102 and the host device 112 may communicate using a local area network (LAN), one or more hardwire connections, a wireless link or router, or an intranet. In some embodiments, the remote device 102 and the host device 112 may be communicatively coupled using a combination of one or more networks and/or one or more local connections. For example, the remote device 102 may be hardwired to the host device 112 (e.g., connected with an Ethernet cable) while a second remote device (not shown) may communicate with the host device using the network 150 (e.g., over the Internet).

In some embodiments, the network 150 can be implemented within a cloud computing environment, or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over the network 150.

In some embodiments, the remote device 102 may enable users to submit (or may submit automatically with or without user input) electronic documents (e.g., textual works such as movie scripts or movie reviews) to the host devices 112 in order to generate an individualized movie rating for a movie. For example, the remote device 102 may include electronic document submission module 110 and a user interface (UI). The electronic document submission module 110 may be in the form of a web browser or any other suitable software module, and the UI may be any type of interface (e.g., command line prompts, menu screens, graphical user interfaces). The UI may allow a user to interact with the remote device 102 to submit, using the document submission module 110, one or more movie scripts or movie reviews to the host device 112. In some embodiments, the remote device 102 may further include a notification receiver module 111. This module may be configured to receive notifications, from the host device 112, such as a notification indicating the individualized movie rating generated by the host device 112.

In some embodiments, a user may scan physical documents into the remote device 102 (or the host device 112). The remote device 102 (or host device 112) may then perform optical character recognition on the scanned documents to convert the document to machine-encoded text. The machine-encoded text may, if necessary, be transmitted to the host device 112 using the document submission module 110 and the user interface.

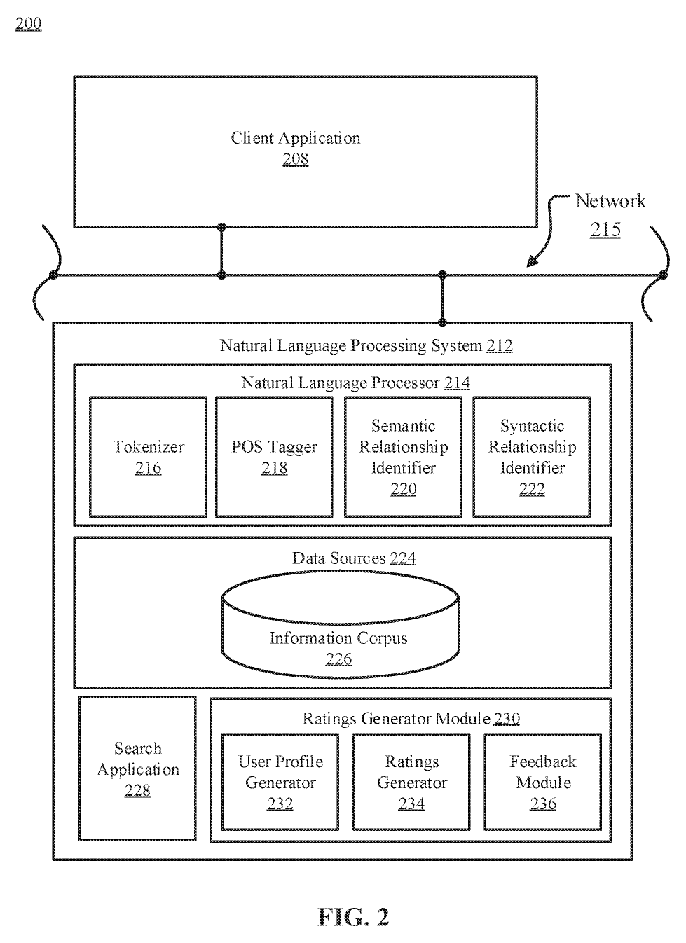

In some embodiments, the host device 112 may include a natural language processing system 122. The natural language processing system 122 may include a natural language processor 124, a search application 126, and a ratings generator module 128. The natural language processor 124 may include numerous subcomponents, such as a tokenizer, a part-of-speech (POS) tagger, a semantic relationship identifier, and a syntactic relationship identifier. An example natural language processor is discussed in more detail in reference to FIG. 2.

The search application 126 may be implemented using a conventional or other search engine, and may be distributed across multiple computer systems. The search application 126 may be configured to search one or more databases or other computer systems for content that is related to an electronic document (such as a movie script) submitted by a remote device 102. For example, the search application 126 may be configured to search a corpus of movie reviews related to a movie script transmitted to the host device 112 by a remote device 102. The ratings generator module 128 may be configured to analyze a movie script of a movie, using a user profile, to generate an individualized rating for the movie. The ratings generator module 128 may include one or more submodules or units, and may utilize the search application 126, to perform its functions (e.g., to generate a user profile, to generate a movie rating, and to adjust the user profile based on received feedback), as discussed in more detail in reference to FIG. 2.

While FIG. 1 illustrates a computing environment 100 with a single host device 112 and a single remote device 102, suitable computing environments for implementing embodiments of this disclosure may include any number of remote devices and host devices. The various modules, systems, and components illustrated in FIG. 1 may exist, if at all, across a plurality of host devices and remote devices. For example, some embodiments may include two host devices. The two host devices may be communicatively coupled using any suitable communications connection (e.g., using a WAN, a LAN, a wired connection, an intranet, or the Internet). The first host device may include a software module configured to generate a user profile based on a user's sensitivities to various ratings components, and the second host device may include a natural language processing system configured to generate an individualized movie rating based on the user profile.

It is noted that FIG. 1 is intended to depict the representative major components of an example computing environment 100. In some embodiments, however, individual components may have greater or lesser complexity than as represented in FIG. 1, components other than or in addition to those shown in FIG. 1 may be present, and the number, type, and configuration of such components may vary.

Referring now to FIG. 2, shown is a block diagram of an example system architecture 200, including a natural language processing system 212, configured to generate an individualized rating for a work of authorship (e.g., a movie) using a user profile, in accordance with embodiments of the present disclosure. In some embodiments, a remote device (such as remote device 102 of FIG. 1) may submit electronic documents (such as a movie script) to be analyzed to the natural language processing system 212 which may be housed on a host device (such as host device 112 of FIG. 1). Such a remote device may include a client application 208, which may itself involve one or more entities operable to generate or modify information in the movie script that is then dispatched to a natural language processing system 212 via a network 215. In some embodiments, the network 215 may be the same as, or substantially similar to, the network 150 of FIG. 1.

Consistent with various embodiments, the natural language processing system 212 may respond to electronic document submissions sent by the client application 208. Specifically, the natural language processing system 212 may analyze a received movie script to generate a movie rating using a user profile. The natural language processing system 212 may generate the user profile for a user using a question and answer system. In some embodiments, the natural language processing system 212 may receive user feedback and adjust a user profile for the user according to the received feedback. In some embodiments, the natural language processing system 212 may include a natural language processor 214, data sources 224, a search application 228, and a ratings generator module 230.

The natural language processor 214 may be a computer module that analyzes the received movie scripts and other electronic documents (e.g., user reviews). The natural language processor 214 may perform various methods and techniques for analyzing electronic documents (e.g., syntactic analysis, semantic analysis, etc.). The natural language processor 214 may be configured to recognize and analyze any number of natural languages. In some embodiments, the natural language processor 214 may parse passages of the documents. Further, the natural language processor 214 may include various modules to perform analyses of electronic documents. These modules may include, but are not limited to, a tokenizer 216, a part-of-speech (POS) tagger 218, a semantic relationship identifier 220, and a syntactic relationship identifier 222.

In some embodiments, the tokenizer 216 may be a computer module that performs lexical analysis. The tokenizer 216 may convert a sequence of characters into a sequence of tokens. A token may be a string of characters included in an electronic document and categorized as a meaningful symbol. Further, in some embodiments, the tokenizer 216 may identify word boundaries in an electronic document and break any text passages within the document into their component text elements, such as words, multiword tokens, numbers, and punctuation marks. In some embodiments, the tokenizer 216 may receive a string of characters, identify the lexemes in the string, and categorize them into tokens.

Consistent with various embodiments, the POS tagger 218 may be a computer module that marks up a word in passages to correspond to a particular part of speech. The POS tagger 218 may read a passage or other text in natural language and assign a part of speech to each word or other token. The POS tagger 218 may determine the part of speech to which a word (or other text element) corresponds based on the definition of the word and the context of the word. The context of a word may be based on its relationship with adjacent and related words in a phrase, sentence, or paragraph. In some embodiments, the context of a word may be dependent on one or more previously analyzed electronic documents (e.g., the content of one movie script may shed light on the meaning of text elements in another movie script, particularly if the movies are part of the same corpus or universe). Examples of parts of speech that may be assigned to words include, but are not limited to, nouns, verbs, adjectives, adverbs, and the like. Examples of other part of speech categories that POS tagger 218 may assign include, but are not limited to, comparative or superlative adverbs, wh-adverbs, conjunctions, determiners, negative particles, possessive markers, prepositions, wh-pronouns, and the like. In some embodiments, the POS tagger 218 may tag or otherwise annotate tokens of a passage with part of speech categories. In some embodiments, the POS tagger 218 may tag tokens or words of a passage to be parsed by other the modules included in the natural language processing system 212.

In some embodiments, the semantic relationship identifier 220 may be a computer module that may be configured to identify semantic relationships of recognized text elements (e.g., words, phrases) in documents. In some embodiments, the semantic relationship identifier 220 may determine functional dependencies between entities and other semantic relationships.

Consistent with various embodiments, the syntactic relationship identifier 222 may be a computer module that may be configured to identify syntactic relationships in a passage composed of tokens. The syntactic relationship identifier 222 may determine the grammatical structure of sentences such as, for example, which groups of words are associated as phrases and which word is the subject or object of a verb. The syntactic relationship identifier 222 may conform to formal grammar.

In some embodiments, the natural language processor 214 may be a computer module that may parse a document and generate corresponding data structures for one or more portions of the document. For example, in response to receiving a movie script at the natural language processing system 212, the natural language processor 214 may output parsed text elements from the movie script as data structures. In some embodiments, a parsed text element may be represented in the form of a parse tree or other graph structure. To generate the parsed text element, the natural language processor 214 may trigger computer modules 216-222.

In some embodiments, the output of the natural language processor 214 may be stored as an information corpus 226 in one or more data sources 224. In some embodiments, data sources 224 may include data warehouses, information corpora, data models, and document repositories. The information corpus 226 may enable data storage and retrieval. In some embodiments, the information corpus 226 may be a storage mechanism that houses a standardized, consistent, clean, and integrated copy of the ingested and parsed movie script(s) or movie review(s). The data may be sourced from various operational systems. Data stored in the information corpus 226 may be structured in a way to specifically address analytic requirements. For example, the information corpus 226 may store the ingested movie scripts as a plurality of narrative blocks, each narrative block relating to a specific scene (or event). This may make generating or adjusting a user profile easier because scenes (or events) tagged by the user as inappropriate may be compared to find a common theme, action, or other reason for the scene being inappropriate. In some embodiments, the information corpus 226 may be a relational database.

In some embodiments, the natural language processing system 212 may include a ratings generator module 230. The ratings generator module 230 may be a computer module that is configured to generate a user profile for a user, identify content that corresponds to one or more ratings components, and provide to the user an individualized movie rating for the movie based on the user's sensitivities. In some embodiments, the ratings generator module 230 may be configured to receive feedback from a user and adjust the user profile for the user based on the feedback.

In some embodiments, the ratings generator module 230 may contain submodules. For example, the ratings generator module 230 may contain a user profile generator 232, a ratings generator 234, and a feedback module 236. The user profile generator 232 may be configured to receive, from a user, a user profile. The user profile may include one or more ratings components (e.g., profanity and scenes with spiders) and a corresponding tolerance level of the user to content that corresponds to the ratings component. In some embodiments, the user profile generator 232 may be configured to generate the user profile instead of receive it. The user profile generator 232 may provide the user with a set of questions. Based on the user's answers to those questions, the user profile generator 232 may generate a user profile for the user.

The ratings generator 234 may be configured to parse a received movie script (or movie reviews) using the natural language processor 214 and related subcomponents 216-222. The ratings generator 234 may then identify, from the parsed movie script, content in the movie that corresponds to the one or more ratings components identified in the user profile that was generated or received by the user profile generator 232. In some embodiments, the ratings generator 234 may use a search application 228 to search a set of (i.e., one or more) corpora (e.g., data sources 224) to identify the content in the movie that corresponds to a ratings component. For example, if one of the ratings components is profanity, the ratings generator 234 may search the parsed movie script for profane words or phrases using a profanity dictionary (e.g., a list of profane words and/or phrases).

After identifying the content in one or more ratings components, the ratings generator 234 may score each ratings component. The score may be based on the number of scenes (or events) in the ratings component, the length of those scenes, and the severity of the scenes, amongst other possible contributors. After generating the component score for each ratings component, the ratings generator 234 may weigh the component scores according to the user profile. The ratings generator 234 may then generate a movie rating for the entire movie by accumulating the weighted component scores for each ratings component. The ratings generator 234 may accumulate the weighted component scores in numerous ways. For example, in some embodiments, the ratings generator 234 may determine the average weighted component score of the plurality of ratings components. As another example, the ratings generator 234 may determine that the movie rating is the same as the highest weighted component score for a ratings component.

The feedback module 236 may be a computer module that is configured to receive, from a user, feedback regarding the user's user profile. The feedback module 236 may then adjust the user profile based on the user's feedback. For example, a user may indicate that a movie rated by the computer system was not properly rated in his opinion. The computer system may prompt the user to select content in the movie (such as an event or theme) that the user found offensive or otherwise inappropriate. In some embodiments, the user may be provided with a list of content that other viewers found to be offensive. The computer system may then prompt the user to select which of the provided potentially offensive content the user found objectionable. The computer system may then analyze the user-identified content to identify events or themes that correspond to a ratings component. For example, the computer system may identify the use of profanity as the only potentially offensive content in the scene(s). The computer system may then adjust the user profile, especially with respect to the potentially offensive content in the scene(s).

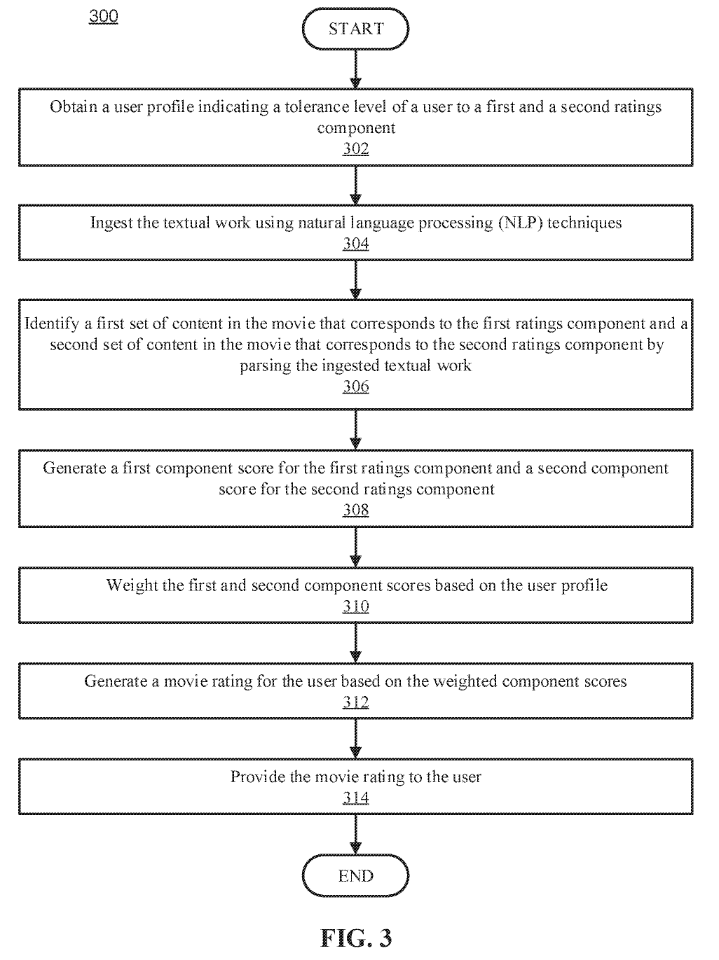

FIG. 3 illustrates a method 300 for generating an individualized movie rating for a movie, in accordance with embodiments of the present disclosure. The method 300 may be performed by a computer system, such as the host device 112 (shown in FIG. 1). In some embodiments, one or more steps or operations of method 300 may be performed by a user, or by the computer system in response to a user's input. The method 300 may begin at operation 302, where the computer system may obtain a user profile for a user. The user profile may indicate a tolerance level of the user to content that falls into a first ratings component and to content that falls into a second ratings component.

In some embodiments, the user may generate his own user profile. The user may then transmit his user profile to the computer system. The user profile may include one or more ratings components. The user may indicate a tolerance level for each ratings component. The tolerance level may indicate how comfortable the user is with content within the ratings component. In some embodiments, the tolerance level may correspond to a recommended age of the viewer. For example, the user may indicate that the level of profanity generally acceptable to people 13 years old or older is also acceptable to him. In some embodiments, the tolerance levels may be based on a scale (e.g., a scale of 1-10, with 1 meaning the user is highly insensitive to content that falls in the ratings component and 10 meaning the user is highly sensitive to the ratings component). For example, the user may indicate that he is highly sensitive to acts of violence (e.g., rate it 8/10), but that he is only moderately sensitive to profanity (e.g., rate it a 4/10). In some embodiments, the scale may be reversed (e.g., a 1 rating indicates a high sensitivity).

In some embodiments, a user may pick a default user profile from a list of predetermined profiles. For example, the user may select a default profile based on his age (or the age of his child). The default profiles may, in some embodiments, be based on other ratings systems. For example, the default profile may be generated based on the “PG-13” rating. In order to generate the default profile that is based on other ratings system (e.g., a default profile based on the PG-13 rating), the computer system may analyze the movie scripts of one or more movies that received the selected rating (e.g., the PG-13 rating). The computer system may then generate a user profile based on the content identified in the analyzed movies. Additionally, the ratings components found in the default profile may correspond to the ratings components used in the ratings system that the profile is based on. For example, if a ratings system rates movies based on violence and profanity, a default profile based on that ratings system would have ratings components for violence and profanity.

In some embodiments, the predetermined profiles may be profiles that were generated for other users based on their sensitivities. The selected profile may be adjusted over time according to the user's changing preferences and viewing habits. For example, in some embodiments, a first user may select a profile that was generated for a second user. When the second user updates their user profile (e.g., in response to determining that his user profile was overly restrictive or as his preferences change over time), the first user's profile may be automatically adjusted to match the updated user profile for the second user. Additionally, movies flagged by the second user as being inappropriate may also be flagged for the first user, even if the computer-generated movie rating for the movies suggests that they are appropriate. Likewise, movies that the first user flags as inappropriate may also be flagged for the second user.

In some embodiments, the computer system may generate the user profile for the user. The computer system may provide the user with a set of questions. The questions can be “yes or no” questions, or they can be questions that require the user to adjust a sliding scale to indicate his tolerance level. For example, the question may ask “Are you afraid of spiders?” If the user answers yes, the computer-generated user profile may indicate that the user does not want to watch movies that include spiders. As another example, the user may be asked “On a scale of 1 to 10, how acceptable is the use of profanity?” The computer system may then determine the user's tolerance level to profanity based on his answer.

After obtaining the user profile at operation 302, the computer system may ingest a textual work using natural language processing techniques at operation 304. The textual work may correspond to a movie. For example, the textual work may be user reviews of the movie, a summary of the movie, or the movie script of the movie.

Natural language processing, as discussed herein, may incorporate any relevant natural processing techniques including, without limitation, those techniques discussed in reference to modules 216-222 in FIG. 2. For example, in embodiments, the natural language processing technique may include analyzing syntactic and semantic content in the movie script. The natural language processing technique may be configured to parse structured data (e.g., tables, graphs) and unstructured data (e.g., textual content containing words, numbers). In certain embodiments, the natural language processing technique may be embodied in a software tool or other program configured to analyze and identify the semantic and syntactic elements and relationships present in the movie script. More particularly, the natural language processing technique can include parsing the grammatical constituents, parts of speech, context, and other relationships (e.g., modifiers) in the movie script. The natural language processing technique can be configured to recognize keywords, contextual information, and metadata tags associated with words, phrases, or sentences related to ratings components (e.g., profanity, violence, etc.). The syntactic and semantic elements can include information such as word frequency, word meanings, text font, italics, hyperlinks, proper names, noun phrases, parts-of-speech, or the context of surrounding words. Other syntactic and semantic elements are also possible.

After ingesting the textual work at operation 304, the computer system may identify a first set of content (e.g., a set of events and/or themes) that corresponds to the first ratings component and a second set of content (e.g., a second set of events and/or themes) that corresponds to the second ratings component by parsing the ingested work using natural language processing techniques at operation 306.

In order to identify content of the movie pertaining to the various ratings components (e.g., the first set of content and the second set of content), the computer system may parse the ingested work to identify events and themes (e.g., depression) found in the work. The events may include, for example actions (e.g., acts of violence), places, visual imagery (e.g., nudity), words (e.g., profanity), or actors (e.g., stalkers). The computer system may then compare the identified events and/or themes to events and/or themes associated with the various ratings components. Based on the comparing, the computer system may identify content of the movie (e.g., events and/or themes) that corresponds to the various ratings components.

For example, the first ratings component may be for profanity. Accordingly, the computer system may analyze a movie script to find the use of a profane word or phrase. Each use of a profane word or phrase may be identified as an event corresponding to the first ratings component and may be included in the first set of content.

Likewise, the second ratings component may be for violence. Accordingly, the computer system may analyze a movie script to find the use of words that denote a violent act (e.g., slap or punch). Each act of violence found in the movie script may be identified as an event that corresponds to the second ratings component and may be included in the second set of content.

After identifying content in the movie that corresponds to the first and second ratings components at operation 306, the computer system may generate a first component score for the first ratings component and a second component score for the second ratings component at operation 308. The component scores may correspond to the amount (e.g., number of events and/or themes) of the content of the movie that falls into the ratings components. For example, the computer system may generate the first component score based on the number of times a profane word or phrase is used.

In some embodiments, the component scores may also correspond to the severity of the content in the ratings components. For example, the first component score may also be based on which profane words or phrases are used, as opposed to just the number of profanities used. For example, a first profanity may be considered worse than a second profanity (either specifically by the user in the user profile or in general). As such, the first profanity may be weighted as more severe than the second profanity. The component scores of other ratings components (e.g., relating to depictions of violence) may also be based on the number of events and the events' severities. For example, a component score for the violence ratings component may be based on the number of events in which depictions of violence are shown or discussed. The depictions of violence may also be weighted based on their severity. For example, comedic violence may be considered less severe than other violence.

The computer system may generate, for each event or theme in a ratings component, a severity score. The severity score may indicate a level of severity for the event. The higher the severity score, the more severe the event may be. The severity scores may be based on, for example, descriptions of the event, the amount of time the event is on-screen, and/or the specific words used to describe the event. The severity score may be used to weight an event according to its severity when generating the component score.

There are several ways that the computer system may determine the severity of events (and, therefore, the severity score) in a ratings component. In some embodiments, the computer system may determine the severity of an event by identifying the time length of the event. For example, a fight scene in a movie that lasts 15 seconds may be considered less severe than a fight scene lasting 3 minutes. Likewise, a provocatively dressed character appearing on the screen for 10 seconds may be considered less severe than a similarly-dressed character appearing for 90 seconds. The computer system may analyze script elements to determine the length of individual events. Script elements (also known as screenplay elements) are elements in a movie script (e.g., sections of text) that help identify different aspects of the movie. For example, a scene heading is often used to identify the place and time in which a scene takes place, an action element describes what the movie watcher is seeing happen on screen, and a dialogue element describes what a character is saying. The computer system may identify the individual elements in the movie script because each element is written in a standard format, including its margins and text styling. Using the script elements, the computer system may determine the length of an event. For example, an action element may indicate that two characters are supposed to fight for 10 seconds.

In some embodiments, the computer system may compare the descriptive words in the movie script relating to the event. For example, the computer system may recognize that some acts of violence (e.g., punching) may be considered more severe than other acts of violence (e.g., slapping). In some embodiments, the computer system may use a dictionary that includes a list of events and an associated severity score for each event to determine the severity of events. For example, an event dictionary for a violence ratings component may include a list of verbs that denote a violent act (e.g., slap, hit, punch, and strike) and a severity score for each violent act. The computer system may also determine the severity of an event by determining the event's outcome. This may be done by determining a relationship between an outcome and an event using natural language processing techniques. For example, a character having a red mark after being slapped may indicate that the event (e.g., the slap) is less severe than an event that results in a character going to the hospital. The appearance of a red mark may be found in an action element (e.g., “Character A slaps Character B, leaving behind a red handprint”). The event's outcome may also be found in the dialogue (e.g., “We need to take Character A to the hospital”).

In some embodiments, the computer system may determine the severity of an event based on whether the event appears on-screen or not. For example, a person being slapped on-screen may be considered more severe than if two characters were simply discussing the event (e.g., talking about a time when a character was slapped). There are numerous ways that the computer system may determine whether an event occurs on-screen or not. In some embodiments, semantic analysis may be sufficient to determine whether an event is happening on-screen. For example, two characters discussing an event in the past tense may be determined by the computer to relate to an event that is not being shown on the screen. In some embodiments, the computer system may identify the script element in which the event takes place to determine whether it is on-screen or not. For example, if an event described in the movie script is written as an action element, the computer system may determine that it is happening on screen. On the other hand, if the event appears in a parenthetical (e.g., the parenthetical in the movie script says “thinking about Character A slapping Character B”), the computer system may determine that the event is happening (or happened) off-screen, and is therefore less severe than had it been on screen. The computer system may determine the severity score for an event based at least in part on whether the event appears on screen or not.

In some embodiments, the computer system may determine the severity of an event using a predetermined list of events that includes the events' severities. This may be particularly useful when determining the severity of words or profanities. For example, the predetermined list of events may include a list of profane words and phrases. Each profane word or phrase may have an associated severity score. The computer system may scan the movie script, particularly looking at dialogue elements, to identify the number of occurrences of each profanity in the predetermined list. The computer system may then generate the component score for the ratings component according to the number of occurrences of an event in the ratings component and the events' severities.

After generating the first and second component scores at operation 308, the computer system may weigh the first and second component scores based on the user profile at operation 310. For example, the user profile may specify that the user is particularly sensitive to depictions of violence, and that the user is particularly insensitive to profanity. Accordingly, the second ratings component (related to violence) may be weighted more than for the general population, while the first ratings component (related to profanity) may be weighted less than for the general population.

After weighting the first and second component scores at operation 310, the computer system may generate an individualized movie rating based on the weighted component scores at operation 312. In some embodiments, the movie rating may be equal to the highest rating score for a ratings component. In some embodiments, the movie rating may be the average of the rating scores. Other ways to accumulate a group of component scores into an overall movie rating (e.g., using other statistical analyses or models, such as finding the mean component score) are readily apparent to a person of ordinary skill in the art. Accordingly, the present disclosure should not be limited to the specific illustrative examples used herein.

After generating the individualized movie rating at operation 312, the computer system may provide the movie rating to the user at operation 314. The computer system may output the movie rating to an attached output device, such as a tablet or smartphone. After providing the movie rating to the user at operation 314, the method 300 may end.

While the method 300 illustrates an example method for weighing two ratings components (e.g., the first and second ratings components), any number of ratings components may be included in a user profile or otherwise considered when determining the movie rating. For example, in some embodiments there may be more than two ratings components that are considered by the computer system generating the movie rating for the user. Additional ratings components may correspond to any type of content that the user may find objectionable (e.g., bats, spiders, etc.). In other embodiments, a single rating component may be considered. This may be done because the user is only concerned with filtering movies that include specific content. For example, a user may not be sensitive to most content (e.g., profanity and violence), but he may find bats terrifying. Accordingly, the user profile may consist of a single ratings component for bats, and the movie rating may be generated based solely on that component.

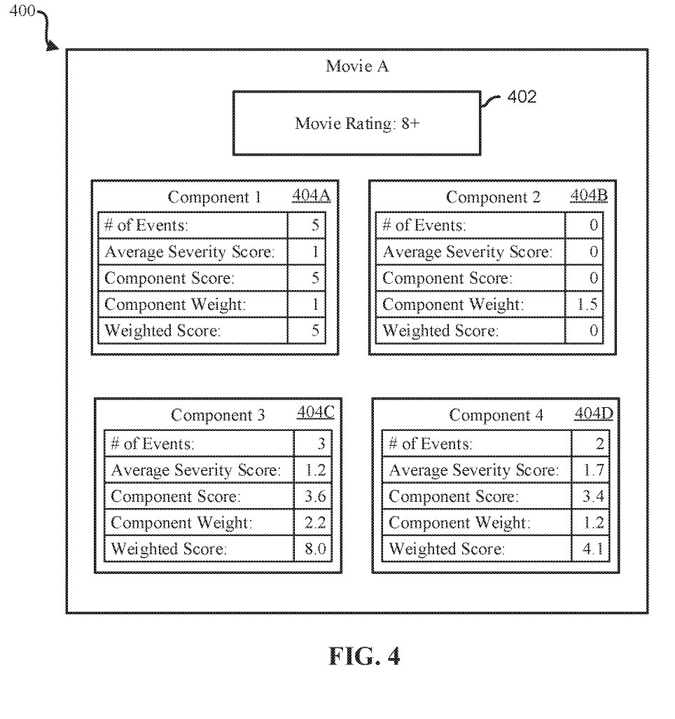

FIG. 4 illustrates an example scorecard 400 for a movie, in accordance with embodiments of the present disclosure. The scorecard 400 may be generated by a computer system and provided to a user. The scorecard may include a rating for the movie 402, as well as the ratings components 404A-404D scored by the computer system to generate the movie rating. Each ratings component 404A-404D may be weighted according to a user profile.

The computer system may identify content (e.g., events and/or themes) related to each ratings component 404A-404D using natural language processing techniques. The computer system may then determine, for each ratings component 404A-404D, the number of events in the movie corresponding to the ratings component and the average severity score of the events. The events may be, for example, actions (e.g., acts of violence), places, visual imagery (e.g., nudity), words (e.g., profanity), or actors (e.g., clowns), as discussed herein. For example, the first ratings component 404A may be for profanity. Accordingly, the number of events shown in the first ratings component 404A may be the number of times a profane word or phrase is used in the movie. As another example, the third ratings component 404C may be for violence. Accordingly, the number of events shown in the third ratings component 404C may be the number of individual acts of violence shown or discussed in the movie.

The average severity score may be determined by averaging the severity scores of each event within a ratings component 404A-404D. For example, the first ratings component 404A may be for profanity. Each profanity may have an associated severity score that describes the severity (to a general audience or specifically to the user) of the profanity relative to other profanities. For example, a profanity with a severity score of 1 may be an average profanity, while profanities with severity scores greater than 1 may be particularly offensive and profanities with severity scores less than 1 may be particularly inoffensive. The computer system may average the severity score for each of the 5 profane words or phrases in the movie to determine the average severity score.

The computer system may then determine a component score for each ratings component. The component scores may be based on, among other things, the number of events and the average severity score of those events. For example, the component score may be the number of events multiplied by the average severity score. For example, the first ratings component 404A (relating to profanity) has 5 identified events and an average severity score of 1. Therefore, the component score for the first ratings component 404A may be 5. Likewise, the third ratings component 404C (relating to violence) includes 3 events (e.g., acts of violence) with an average severity score of 1.2. Accordingly, the component score for the third ratings component 404C may be 3.6.

After determining the component scores for each ratings component, the computer system may determine the rating components' weights. The ratings components' weights may be based on the user profile. For example, a user profile may dictate that profanity (e.g., the first ratings component 404A) should be moderately weighted, whereas violence (e.g., the third ratings component 404C) should be heavily weighted. Accordingly, the first ratings component 404A may have a component weight of 1, while the third ratings component 404C may have a component weight of 2.2.

The computer system may then determine a weighted score for each ratings component. The computer system may determine the weighted scores by multiplying the component score by the component weight. For example, the first ratings component 404A may have a component score of 5 and a component weight of 1. Accordingly, the weighted score for the first ratings component 404A may be 5. Likewise, the third ratings component 404C may have a component score of 3.6 and a component weight of 2.2. Therefore, the weighted score for the third ratings component 404C may be 8.

The computer system may then use the weighted scores for each ratings component to determine the overall movie rating 402. As discussed above, the movie rating 402 may be the maximum of the weighted ratings component scores. In the example shown in FIG. 4, the movie rating 402 is “8+” (e.g., indicating that the movie is appropriate for users aged 8 and older), which is the weighted score of the third ratings component 404C (corresponding to violence), which has the largest weighted score of any ratings component. In some embodiments, the movie rating may be determined using a formula that accounts for each individual ratings component (e.g., an average of every component), instead of only the ratings component with the highest weighted score.

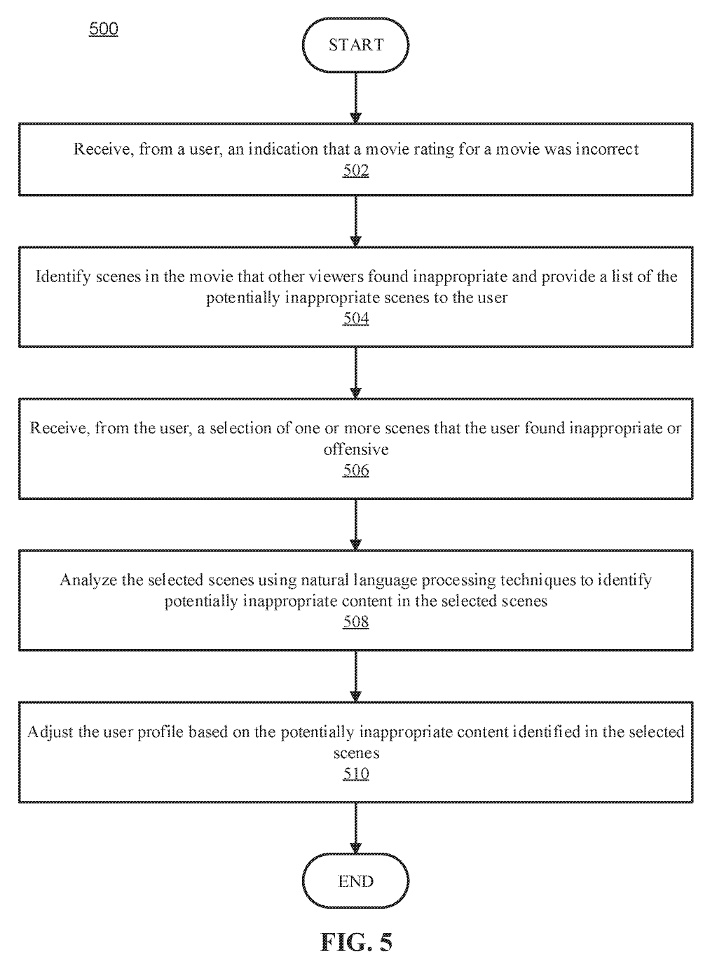

FIG. 5 illustrates a flowchart of an example method 500 for adjusting a user profile based on feedback received from a first user, in accordance with embodiments of the present disclosure. The method 500 may be performed by a computer system. In some embodiments, one or more steps or operations of the method 500 may be performed by a user (such as the first user). The method 500 may begin at operation 502, wherein a computer system may receive, from the first user, an indication that a movie rating for a movie was incorrect.

The first user may determine that a movie rating for a specific movie was not correct. For example, the first user may determine that a binary movie rating (e.g., a movie rating of appropriate) was wrong because the movie was not appropriate despite being rated as appropriate. As another example, the first user may determine that a movie rated as appropriate for a viewer of a certain age was actually inappropriate for that viewer. As yet another example, the first user may determine that a movie rated as inappropriate was actually appropriate for the user. Accordingly, the first user may flag the movie as having an inaccurate rating.

After the computer system receives an indication that the movie rating for the movie was incorrect at operation 502, the computer system may identify scenes in the movie that other viewers found inappropriate and provide a list of the potentially inappropriate scenes to the first user at operation 504. In some embodiments, the computer system may identify scenes that other users of the individualized movie ratings system flagged.

For example, a second user of the individualized movie ratings system may have previously flagged the movie as having an inaccurate movie rating. The second user may have then identified one or more scenes in the movie that the second user found particularly offensive. The scenes identified by the second user may then be provided to other users (such as the first user) if they also flag the movie as being incorrectly rated. Accordingly, the computer system may provide one or more scenes flagged by the second (or other) user to the first user.

In some embodiments, the computer system may perform sentiment analysis on movie reviews (such as movie reviews posted to a website) to identify scenes or content (e.g., events or themes) that other viewers found inappropriate, offensive, or difficult to watch. For example, a movie review might mention that a particular scene was difficult to watch because it had a clown in it. The computer system may then compare the user review to the movie script to identify the specific scene that the reviewer struggled to watch. The computer system may then provide that scene to the first user (e.g., all scenes that include clowns).

After the computer system provides a list of the potentially inappropriate scenes to the user at operation 504, the computer system may receive, from the first user, a selection of one or more scenes that the first user found inappropriate or offensive at operation 506. The first user may select each of the scenes that he felt were inappropriate given the computer-generated movie rating.

In some embodiments, the first user may select the scenes that he felt were inappropriate from a list of scenes in the movie in addition to, or instead of, receiving a list of scenes that other users found inappropriate. This may be done by identifying timestamps in the movie where the inappropriate scenes occurred, for example. Alternatively, the first user may describe the particular scene that he found inappropriate. The computer system may then ingest the description of the scene using natural language processing techniques. The computer system may compare the ingested description to the ingested textual work (e.g., the movie script). Based on this comparison, the computer system may identify the potential scene(s) that the first user may have found inappropriate. The computer system may provide a list of the potential scenes to the first user, and the first user may select the scene(s) that he found inappropriate.

After the computer system receives a selection of one or more scenes that the first user found inappropriate at operation 506, the computer system may analyze the selected scenes using natural language processing techniques to identify potentially inappropriate content in the selected scenes at operation 508. The computer system may parse the movie script (in particular, the parts of the movie script corresponding to the selected scenes) and identify content (e.g., events and/or themes) in the movie script that corresponds to one or more of the ratings components in the user profile as discussed in more detail in reference to FIG. 3.

After identifying potentially inappropriate content in the selected scenes at operation 508, the computer system may adjust the user profile based on the potentially inappropriate content identified in the selected scenes at operation 510. For example, if the potentially inappropriate content was the use of profanity, the computer system may adjust the weighting coefficient for the profanity ratings component (e.g., to increase the weight given to profanity when generating movie ratings for the user). As another example, if the flagged scenes all included bats, the computer system may adjust the user profile to indicate that the user does not like bats.

In some embodiments, the computer system may identify content that is common to each scene identified by the user as inappropriate that is not part of the user profile (e.g., does not have a corresponding ratings component). For example, the user profile may not include a ratings component for clowns, but each identified scene includes a clown. In these embodiments, the computer system may add a new ratings component for the identified content (e.g., for clowns) and generate a preliminary tolerance level for the new ratings component.

In some embodiments, the computer system may ask the user to rate the identified scenes (e.g., on a scale from 1-10) based on how inappropriate the user found the scenes to be. The computer system may then determine that the user profile should be adjusted based on the user's rating. For example, the preliminary tolerance level for a new ratings component may be based on (e.g., the maximum or average of) the user's rating for the scenes. As another example, the user profile may indicate a tolerance level of 5/10 for profanity. If each identified scene includes profanity, but no content related to other ratings components, and the user rated each scene a 7/10, the computer system may update the user profile's tolerance level for profanity to 7/10. After the computer system adjusts the user profile at operation 510, the method 500 may end.

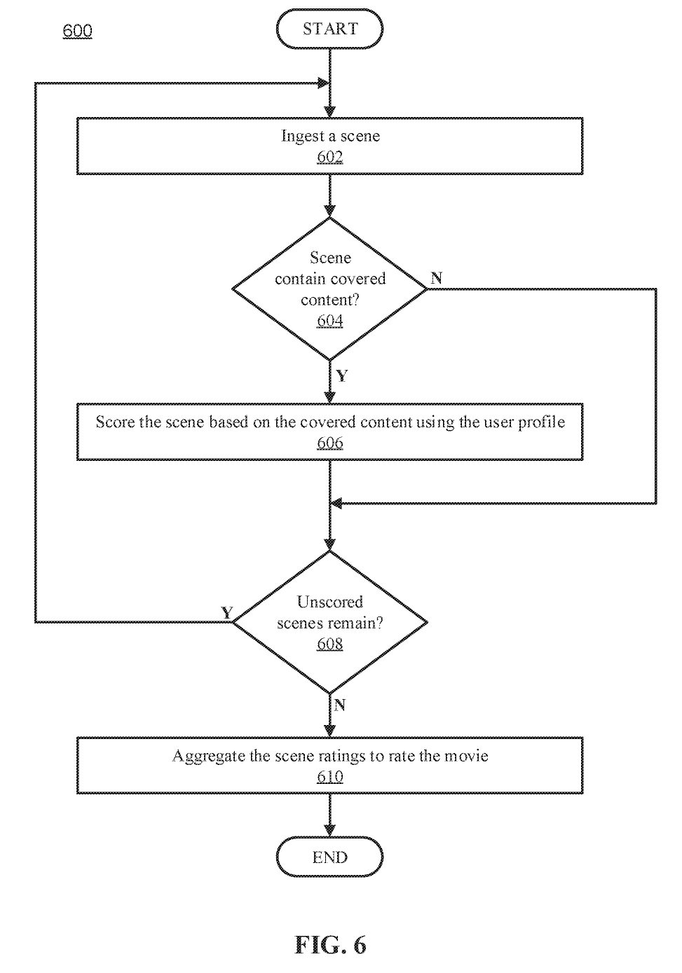

FIG. 6 illustrates a flowchart of another method 600 for generating an individualized rating for a work of authorship based on user preferences, in accordance with embodiments of the present disclosure. The method 600 may be performed by a computer system, such as the host device 112 (shown in FIG. 1). In some embodiments, one or more steps or operations of method 600 may be performed by a user, or by the computer system in response to a user's input. The method 600 may begin at operation 602, where the computer system may ingest a scene of a movie.

In some embodiments, the computer system may ingest a textual work related to the scene using natural language processing techniques. For example, the textual work may be user reviews of a scene in a movie, a summary of the scene, or a part of the movie script of the movie for the scene. In some embodiments, the computer system may perform optical character recognition (OCR) on a scanned document (e.g., on a scanned copy of the movie script) to convert the document into machine-encoded text (e.g., to create an electronic version of the document in machine-encoded text). The computer system may then ingest the electronic version of the document using natural language processing techniques.

Natural language processing, as discussed herein, may incorporate any relevant natural processing techniques including, without limitation, those techniques discussed in reference to modules 216-222 in FIG. 2. For example, in embodiments, the natural language processing technique may include analyzing syntactic and semantic content in the movie script. The natural language processing technique may be configured to parse structured data (e.g., tables, graphs) and unstructured data (e.g., textual content containing words, numbers). In certain embodiments, the natural language processing technique may be embodied in a software tool or other program configured to analyze and identify the semantic and syntactic elements and relationships present in the movie script. More particularly, the natural language processing technique can include parsing the grammatical constituents, parts of speech, context, and other relationships (e.g., modifiers) in the movie script. The natural language processing technique can be configured to recognize keywords, contextual information, and metadata tags associated with words, phrases, or sentences related to ratings components (e.g., profanity, violence, etc.). The syntactic and semantic elements can include information such as word frequency, word meanings, text font, italics, hyperlinks, proper names, noun phrases, parts-of-speech, or the context of surrounding words. Other syntactic and semantic elements are also possible.

In some embodiments, the computer system may convert audio (such as from a song or the audio of a scene in a movie) to text. The computer system may use speech recognition techniques to transcribe the audio of the scene to generate a transcription of the scene. The computer system may then ingest the transcription of the scene using natural language processing techniques, as discussed herein.

In some embodiments, the computer system may analyze the video of the scene. The computer system may use image analysis techniques to identify content in the scene. For example, the computer system may identify snakes or bats in the scene using image analysis. In some embodiments, the computer system may have one or more image processing modules configured to identify different types of content. For example, the computer system may have an image processing module that is configured to perform object recognition (e.g., to identify animals such as bats and/or snakes). As another example, the computer system may have an image processing module that is configured to perform facial recognition (e.g., to identify clowns).

In some embodiments, the computer system may tailor the image analysis based on a textual work related to the scene. For example, the computer system may perform natural language processing techniques to parse the movie script of the scene (or to parse the transcription of the audio). The computer system may then identify content that is likely to be shown on the screen based on the parsed text. For example, if the parsed text includes a reference to a snake, the computer system may determine that a snake is likely to be shown in the video. The computer system may then use image analysis techniques to determine whether the snakes are actually shown in the video (e.g., use an object recognition module to scan still frames of the scene for a snake).

After ingesting a scene at operation 602, the computer system may determine whether the scene contains covered content at decision block 604. Covered content, as used herein, may include any content identified in the movie script, a transcription of the audio, or using image analysis techniques that falls in a ratings component in a user profile. The computer system may compare each ratings category in the user profile to the ingested information (e.g., the ingested transcript or image data) to determine whether the scene includes covered content. For example, a user profile may include a first ratings component for snakes and a second ratings component for profanity. Accordingly, the computer system may analyze the ingested scene to determine whether it includes a snake (e.g., a discussion of snakes by characters in the scene or a depiction of a snake in the video of the scene) and whether it includes the use of profanity.

If the computer system determines that the scene does not contain covered content at decision block 604, the method 600 may progress to decision block 608. Otherwise, the computer system may score the scene based on the covered content using a user profile at operation 606. The user profile may include a tolerance level for each type of covered content (e.g., for each ratings component), as discussed herein. For example, the user profile may include a tolerance level for violence and profanity. The tolerance level for violence may be 8/10 (meaning that the user is sensitive to acts of violence), and the tolerance level for profanity may be 3/10, meaning that the user is relatively insensitive to the use of profanity in movies.

In some embodiments, the computer system may determine the ratings components to which the scene corresponds. For example, a scene that includes profanity may correspond to the profanity ratings component Likewise, a scene that includes profanity and clowns may correspond to both the profanity ratings component and the clown ratings component. After determining which ratings components correspond to the scene, the computer system may use the user profile for the user to determine what the user's tolerance level is for each ratings component. The computer system may then determine, based on the tolerance levels for the user and the ratings components that correspond to the scene, a scene rating for the scene.

In some embodiments, the scene rating may be the same as the highest tolerance level for a ratings component that corresponds to a scene. For example, a scene may include both profanity and violence. A user profile for the user may indicate that his tolerance level for violence is 8/10 (meaning that the user is sensitive to acts of violence), and his tolerance level for profanity may be 3/10, meaning that the user is relatively insensitive to the use of profanity in movies. Accordingly, the computer system may score the scene as an 8/10. In some embodiments, the scene rating may be the average of the tolerance levels for ratings components that correspond to the scene. Using the previous example, the computer system may determine that the scene score is 5.5/10 (e.g., the average of the profanity and violence tolerance levels). Other methods for combining individual scores into an overall score will be apparent to persons of ordinary skill in the art, and the present disclosure should not be limited to the example methods used herein.

After scoring the scene at operation 606, the computer system may determine whether any unscored scenes remain at decision block 608. If unscored scenes remain, the method may return to operation 602 and the new scene may be ingested. If no additional scenes are unscored, the computer system may aggregate the scene ratings to determine a rating for the entire movie at operation 610.

In some embodiments, the movie rating may be the same as the highest scene rating. For example, a movie may contain 4 scenes. The first scene may have a scene rating of 8/10 (e.g., because it includes acts of violence); the second scene may have a scene rating of 3/10 (e.g., because it includes profanity but no violence); and, the third and fourth scenes may be rated 2/10 (e.g., because they include snakes but do not include profanity or acts of violence). Accordingly, the computer system may determine that the movie rating is 8/10. In some embodiments, the movie rating may be the average of the scene ratings. Using the previous example, the computer system may determine that the movie rating is 3.75/10 (e.g., the average of the four scene ratings). Other methods for combining scene ratings into an overall movie rating will be apparent to persons of ordinary skill in the art, and the present disclosure should not be limited to the example methods used herein.

After aggregating the scene ratings to determine a movie rating at operation 610, the method 600 may end.

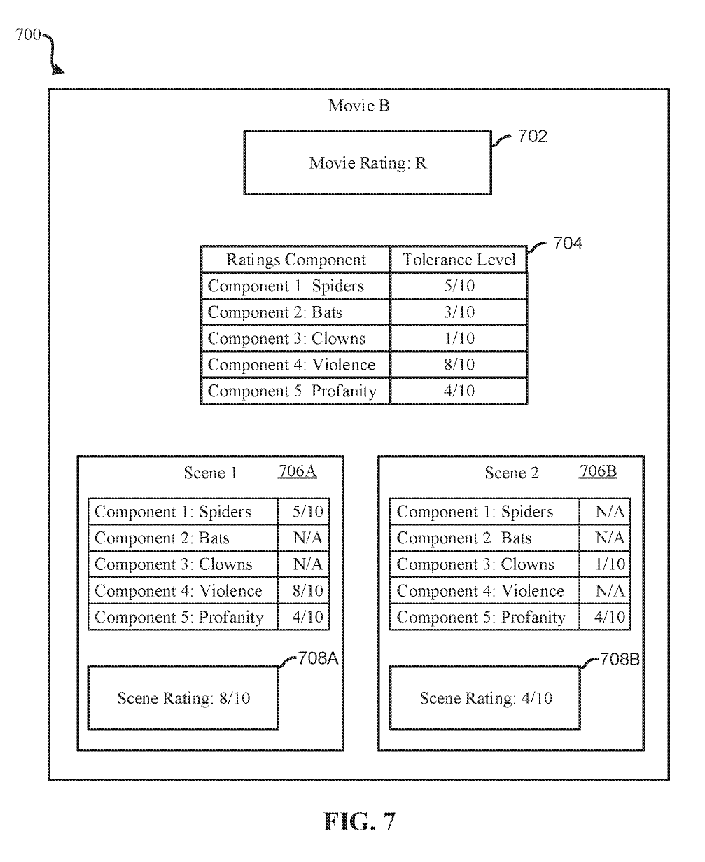

FIG. 7 illustrates an example scorecard 700 for a movie (Movie B) showing the ratings for each scene in the movie, in accordance with embodiments of the present disclosure. The scorecard 700 may be generated by a computer system and provided to a user. The scorecard 700 may include a movie rating 702, a user profile 704, and scene ratings for the two scenes 706A and 706B in the movie. Each scene 706A and 706B may be scored based on the content corresponding to a ratings component (e.g., covered content) found in the scene and the tolerance level of the user to the covered content, as determined by the user profile 704.

The user profile 704 may include five ratings components and the user's tolerance level to content corresponding to each ratings component. For example, as shown in FIG. 7, the first ratings component in the user profile may correspond to spiders and have a tolerance level of 5/10; the second ratings component may correspond to bats and have a tolerance level of 3/10; the third ratings component may correspond to clowns and have a tolerance level of 1/10; the fourth ratings component may correspond to violence and have a tolerance level of 8/10; and the fifth ratings component may correspond to profanity and have a tolerance level of 4/10.

Each scene 706A and 706B may be scored for each ratings component based on whether or not the scene includes content corresponding to the ratings component. For example, the first scene 706A may include at least one depiction of a spider. Accordingly, the scene may be scored a 5/10 for the first ratings component (e.g., because the user's tolerance level towards spiders is 5/10). The first scene 706A may not include depictions of bats or clowns and, therefore, may not have a score for the second or third ratings components. The first scene may include at least one depiction of an act of violence and at least one use of a profanity. Accordingly, the scene may be scored an 8/10 for the fourth ratings component (e.g., the user's tolerance level for violence) and a 4/10 for the fifth ratings component (e.g., the user's tolerance level for profanity). Likewise, the second scene 706B, which does not include spiders, bats, or violence, may have a score of 1/10 for the third ratings component because it does include at least one depiction of a clown and a 4/10 for the fifth ratings component because it does include at least one use of a profanity.

Each scene may also have a scene rating 708A and 708B. The scene ratings 708A and 708B may be based on the most severe covered content in the scene, as determined based on the tolerance levels specified in the user profile 704. For example, the first scene 706A includes bats (scored 5/10 using the user profile 704), violence (scored 8/10), and profanity (scored 4/10). Based on those scores, the scene ratings 708A for the first scene 706A may be 8/10. Likewise, the second scene 706B may have a scene rating 708B of 4/10 due to the use of profanity in the second scene 706B.

In some embodiments, the movie rating 702 may be determined based on the scene ratings 708A and 708B of the various scenes 706A and 706B. The movie rating 702 may be based on the highest (e.g., most severe) scene rating. For example, the scene rating 708A for the first scene 706A may determine the movie rating 702 for Movie B because the first scene 706A may be rated as more severe (e.g., less appropriate) than the second scene 706B.

In some embodiments, the movie rating 702 may be in a different format than the scene ratings 708A and 708B. For example, the scene ratings 708A and 708B may be based on the user's tolerance levels for various content using a 0-10 sliding scale. The computer system may first determine the movie rating 702 using the 0-10 sliding scale. For example, the computer system may first determine that the movie rating 702 is an 8/10 because the first scene 706A is rated an 8/10. Because most users may be more familiar with a different ratings system for movies (e.g., a ratings system that uses G, PG, PG-13, R, and NC-17 ratings), the computer system may then convert the numerical movie rating into an equivalent rating from another ratings system. For example, the computer system may determine that a numerical movie rating of 0-2 corresponds with the G rating, 3-4 corresponds with the PG rating, 5-6 corresponds with the PG-13 rating, 7-9 corresponds with the R rating, and 10 corresponds with the NC-17 rating. Because the movie has a numerical rating of 8/10, the computer system may determine that the movie rating 702 is the R rating for the given user.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the foregoing detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the foregoing description, numerous specific details were set forth to provide a thorough understanding the various embodiments. But, the various embodiments may be practiced without these specific details. In other instances, well-known circuits, structures, and techniques have not been shown in detail in order not to obscure embodiments.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the invention.

What is claimed is:

1. A computer-implemented method comprising:
receiving a textual work by an input device coupled to a computer system, the computer system having a processor and a memory storing one or more natural language processing modules executable by the processor to ingest the textual work, the textual work being related to a work of authorship;
ingesting the textual work using the natural language processing modules;
identifying, based on the ingesting, content in the work of authorship that corresponds to one or more ratings components;
obtaining a user profile, the user profile indicating a tolerance level of a user to at least one of the one or more ratings components; and
generating, based on the identified content and the user profile, a rating for the work of authorship, the rating indicating an appropriateness level of the work of authorship.

2. The method of claim 1, wherein the obtaining the user profile comprises receiving, from the user, the user profile.

3. The method of claim 1, wherein the obtaining the user profile comprises generating, by the computer system, the user profile.

4. The method of claim 3, wherein the generating the user profile comprises: providing the user with a series of questions, each question relating to at least one of the one or more ratings components;
receiving, from the user, one or more answers, each answer relating to a question in the series of questions; and
scoring, for each of the at least one of the one or more ratings components, the one or more answers provided by the user to determine the tolerance level of the user for each of the at least one of the one or more ratings components.

5. The method of claim 1, wherein the appropriateness level is a recommended minimum age of a viewer.

6. The method of claim 1, wherein the work of authorship is a movie.

7. The method of claim 6, wherein the generating the rating for the movie comprises:
generating one or more component scores, the one or more component scores including a component score for each of the one or more ratings components; and
weighting the one or more component scores according to the user profile.

8. The method of claim 6, wherein the identifying the content in the movie that corresponds to one or more ratings components comprises:
identifying a first ratings component;
parsing the ingested textual work using natural language processing; and
identifying, based on the parsing, first content of the movie that corresponds to the first ratings component.

9. The method of claim 8, wherein the identifying the content in the movie that corresponds to one or more ratings components further comprises:
identifying a second ratings component; and
identifying, by parsing the ingested textual work using natural language processing, second content of the movie that corresponds to the second ratings component.

10. The method of claim 9, wherein the user profile indicates a first tolerance level of the user to the first ratings component and a second tolerance level of the user to the second ratings component, and wherein the generating the rating for the movie comprises:
generating a first component score for the first ratings component and a second component score for the second ratings component; and
weighting the first component score based on the first tolerance level and the second component score based on the second tolerance level.

11. The method of claim 6, wherein the textual work is selected from a group consisting of a movie script of the movie and one or more user reviews of the movie.

12. The method of claim 6, the method further comprising providing, to the user, an individualized scorecard for the movie, the individualized scorecard indicating the rating for the movie and component scores for the one or more ratings components.

13. A system comprising:
an input device;
an output device;
a memory having one or more natural language processing modules;
a processor in communication with the memory, the processor being configured to perform a method comprising:
receiving a textual work by the input device, the textual work being related to a work of authorship;
ingesting the textual work using the natural language processing modules;
identifying, based on the ingesting, content in the work of authorship that corresponds to one or more ratings components;
obtaining a user profile, the user profile indicating a tolerance level of a user to at least one of the one or more ratings components;
generating, based on the identified content and the user profile, a rating for the work of authorship, the rating indicating an appropriateness level of the work of authorship; and
outputting the rating for the work of authorship to the output device.

14. The system of claim 13, wherein the obtaining the user profile comprises:
providing the user with a series of questions, each question relating to at least one of the one or more ratings components;
receiving, from the user, one or more answers, each answer relating to a question in the series of questions; and
scoring, for each of the at least one of the one or more ratings components, the one or more answers provided by the user to determine the tolerance level of the user for each of the at least one of the one or more ratings components.

15. The system of claim 13, wherein the work of authorship is a movie, and wherein the identifying the content in the movie that corresponds to one or more ratings components comprises:
identifying a first ratings component;
identifying a second ratings component;
parsing the ingested textual work using natural language processing;
identifying, based on the parsing, first content of the movie that corresponds to the first ratings component; and
identifying, based on the parsing, second content of the movie that corresponds to the second ratings component.

16. The system of claim 15, wherein the user profile indicates a first tolerance level of the user to the first ratings component and a second tolerance level of the user to the second ratings component, and wherein the generating the rating for the movie comprises:
generating a first component score for the first ratings component and a second component score for the second ratings component; and
weighting the first component score based on the first tolerance level and the second component score based on the second tolerance level.

17. A computer program product comprising a computer readable storage medium having program instructions embodied therewith, the program instructions executable by a processor to cause the processor to perform a method comprising:
receiving a textual work by an input device coupled to a computer system, the computer system including the processor and a memory storing one or more natural language processing modules executable by the processor to ingest the textual work, the textual work being related to a work of authorship;
ingesting the textual work using the one or more natural language processing modules;
identifying, based on the ingesting, content in the work of authorship that corresponds to one or more ratings components;
obtaining a user profile, the user profile indicating a tolerance level of a user to at least one of the one or more ratings components;
generating, based on the identified content and the user profile, a rating for the work of authorship, the rating indicating an appropriateness level of the work of authorship; and
outputting the rating for the work of authorship to an output device.

18. The computer program product of claim 17, wherein the obtaining the user profile comprises:
providing the user with a series of questions, each question relating to at least one of the one or more ratings components;
receiving, from the user, one or more answers, each answer relating to a question in the series of questions; and
scoring, for each of the at least one of the one or more ratings components, the one or more answers provided by the user to determine the tolerance level of the user for each of the at least one of the one or more ratings components.

19. The computer program product of claim 17, wherein the work of authorship is a movie, and wherein the identifying the content in the movie that corresponds to one or more ratings components comprises:
identifying a first ratings component;
identifying a second ratings component;
parsing the ingested textual work using natural language processing;
identifying, based on the parsing, first content of the movie that corresponds to the first ratings component; and
identifying, based on the parsing, second content of the movie that corresponds to the second ratings component.

20. The computer program product of claim 19, wherein the user profile indicates a first tolerance level of the user to the first ratings component and a second tolerance level of the user to the second ratings component, and wherein the generating the rating for the movie comprises:
generating a first component score for the first ratings component and a second component score for the second ratings component; and
weighting the first component score based on the first tolerance level and the second component score based on the second tolerance level.
